(19) United States
(12) Patent Application Publication
(10) Pub. No.: US 2021/0002967 A1
(43) Pub. Date: Jan. 7, 2021

(54) DOWNHOLE ROLLER

(71) Applicant: Schlumberger Technology Corporation, Sugar Land, TX (US)

(72) Inventors: Sashank Vasireddy, Pune (IN); Stephen Walter Jeske, Manvel, TX (US); Bendang Aomeren Imchen, Pune (IN); Derek Copold, Sugar Land, TX (US)

(21) Appl. No.: 17/027,201

(22) Filed: Sep. 21, 2020

Related U.S. Application Data
(63) Continuation-in-part of application No. 14/849,149, filed on Sep. 9, 2015, now Pat. No. 10,781,647.

(51) Int. Cl. E21B 17/10; F16C 33/34

(52) U.S. Cl. CPC E21B 17/1057; F16C 2352/00; F16C 33/34

(57) ABSTRACT

A downhole roller having a body. The downhole roller also has a wheel connected with the body, and a bearing assembly disposed between the body and the wheel to allow the wheel to move relative to the body. The downhole roller can also have an internal shaft between the wheel and the bearing assembly, wherein the internal shaft holds the bearing assembly in place.

### CROSS-REFERENCE TO RELATED APPLICATIONS

This Application is a continuation-in-part application of co-pending U.S. Non-Provisional patent application Ser. No. 14/849,149, titled “Downhole Roller,” filed on Sep. 9, 2015, which is incorporated by reference herein in its entirety for all purposes.

### BACKGROUND

During the conveyance of wireline tools, the toolstring is often subjected to friction. To make conveyance of wireline tools more efficient and reduce the risk of sticking during conveyance, rollers are often used with the toolstring. The rollers are often retained using external mechanism; however, these mechanisms are hard to maintain and take up significant space.

### SUMMARY

An example downhole roller includes a body. The body has a wheel connected therewith. A bearing assembly is disposed between the body and the wheel to allow the wheel to move relative to the body. An internal shaft is located between the wheel and the bearing assembly. The internal shaft holds the bearing assembly in place.

An example method of conveying a tool into a wellbore includes connecting a toolstring with a downhole roller. The downhole roller includes a body with a wheel connected therewith. A bearing assembly is disposed between the body and the wheel to allow the wheel to move relative to the body. The downhole roller also includes an internal shaft between the wheel and the bearing assembly, and the internal shaft holds the bearing assembly in place. The method also includes running the toolstring and downhole roller into the wellbore.

An example system for conveying a tool into a wellbore includes a downhole roller. The downhole roller includes a body with a wheel connected therewith. A bearing assembly is disposed between the body and the wheel to allow the wheel to move relative to the body. The downhole roller also includes an internal shaft between the wheel and the journal assembly, and the internal shaft holds the bearing assembly in place. The example system also includes a toolstring having at least one downhole tool. A conveyance is connected with the toolstring.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts an example system for conveying a tool into a wellbore.

FIG. 2 depicts an example downhole roller.

FIG. 3 depicts an example roller having retaining lips formed on a surface thereof

FIG. 4 depicts an example standoff having retaining lips formed on a surface thereof

FIG. 5 depicts an example method of conveying a downhole tool.

FIG. 6 depicts an example system having a roller assembly and a downhole tool.

FIG. 7 depicts an example roller assembly in an open configuration.

FIG. 8 depicts an example roller assembly in a closed configuration.

FIG. 9 depicts an example roller assembly having an angled orienting feature.

FIG. 10 depicts an example downhole assembly in a stable configuration within a wellbore.

FIG. 11 depicts an example downhole assembly in an unstable configuration within a wellbore.

FIG. 12 depicts an example roller assembly having counter-weight features.

FIG. 13 depicts an example roller assembly having counter-weight features.

FIG. 14 depicts an example orienting feature of a roller assembly, where the orienting feature has a triangular shape.

FIG. 15 depicts an example orienting feature of a roller assembly, where the orienting feature has an oblong shape.

FIG. 16 depicts an example orienting feature of a roller assembly, where the orienting feature has a ribbed shape.

FIG. 17 depicts an example roller assembly having a ribbed orienting feature.

FIG. 18 depicts an example roller assembly having augmented wheels, where the roller assembly is in a closed configuration.

FIG. 19 depicts an example roller assembly having augmented wheels, where the roller assembly is in an open configuration.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

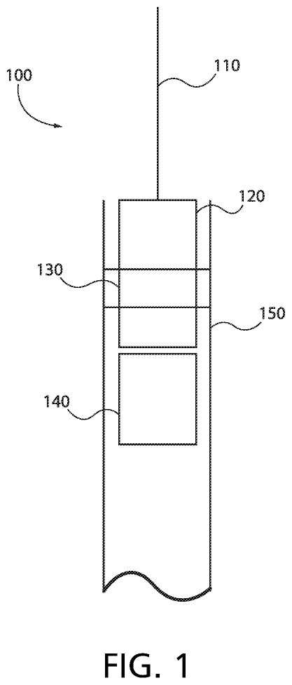

FIG. 1 depicts an example system for conveying a tool into a wellbore. The system 100 includes a conveyance 110, a toolstring 120, one or more downhole rollers 130, and one or more downhole tools 140. The conveyance 110 can be a slickline, wireline, coil tubing, drill string, or the like.

The toolstring 120 can have one or more segments. The segments can include electronic modules, hydraulic modules, sensors, communication equipment, and any other suitable equipment.

The downhole roller 130 can have one or more wheels connected with a body. The body can be configured to connect about the toolstring 120. The downhole roller 130 can reduce friction between the toolstring 120 and wellbore walls 150 during conveyance. The downhole roller 130 can also mitigate sticking by preventing damage to mud on the side of the wellbore walls 150, thereby preventing differential pressure sticking.

The downhole tool 140 can be a milling tool, a cutting tool, a shifting tool, an anchor, a tractor, a perforating gun, a logging tool, or the like.

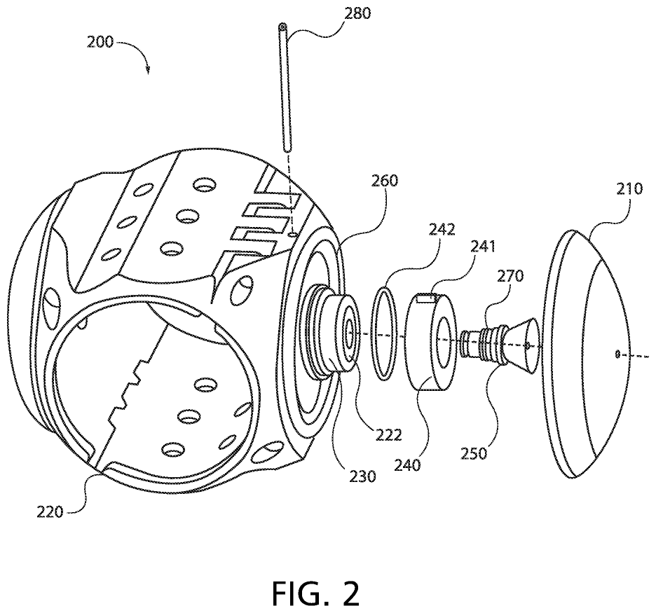

FIG. 2 depicts an example downhole roller. The downhole roller 200 includes a body 220, one or more wheels 210, one or more internal shafts 250, one or more outer journal bearings 240, one or more retaining rings 242, one or more static seals 270, one or more inner journal bearings 230, one or more rotating seals 260, and one or more locking pins 280.

The body 220 can have a wheel 210 connected on one side thereof and another wheel connected on the other side. Both wheels can be connected to the body in the same way; however, a detail of the wheel connection is only shown for one of the wheels 210.

The wheel 210 can be connected with the body 220 by a bearing assembly that includes an inner journal bearing 230 and an outer journal bearing 240. The inner journal bearing 230 can be placed about a threaded cylinder 222 connected with the body 220. A static seal 270 can be placed about the shaft 250, and the static seal can seal against a land in the threaded cylinder 222. The internal shaft 250 can be threaded to the threaded cylinder 222, holding the journal bearings 230 and 240 in place. The lock pin 280 can be engaged with the internal shaft 250 to prevent the internal shaft from unthreading.

The body 220 can have the rotating seal 260 located thereon. The rotating seal 260 can be on a rotating bearing.

The wheel 210 can be placed about the bearing assembly and a retaining ring 242 can hold the wheel 210 in place. Accordingly, the outer journal bearing 240 can rotate about the inner journal bearing 230, allowing the wheel 210 to rotate relative to the body 220. The key 241 can prevent the outer journal bearing from rotating relative to the wheel 210.

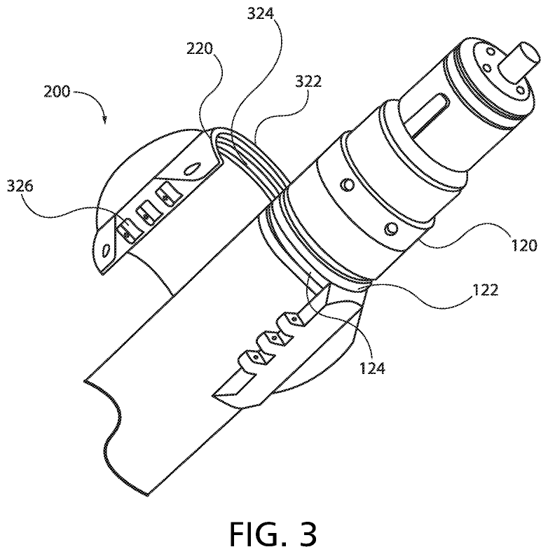

FIG. 3 depicts an example roller having retaining lips formed on a surface thereof

The roller 200 can have a body 220. The body 220 has one or more retaining lips 322 and 324 located thereon. The retaining lips 322 and 324 can be formed, connected with, or otherwise located on the body 220. The lips 322 and 324 can be configured to fit in retaining grooves 122 and 124 formed on a toolstring 120. The upper retaining lip 322 can be larger than the retaining lip 324 and act as a point of retention to prevent substantial axial movement of the body 220 relative to the toolstring 120. The lower retaining lip 324 can be smaller and act as a failsafe to prevent incorrect installation onto the toolstring 120. For example, the lower retaining lip 324 can be spaced from the upper lip so that if the roller is installed the wrong direction on the toolstring 120, the lower retaining lip will act as a stop on the toolstring and prevent the pin end 326 from closing, thereby preventing installation of the roller onto the toolstring 120.

A similar method can be used with other accessories, for example a standoff can be formed with retaining lips formed thereon and the toolstring can have similar grooves.

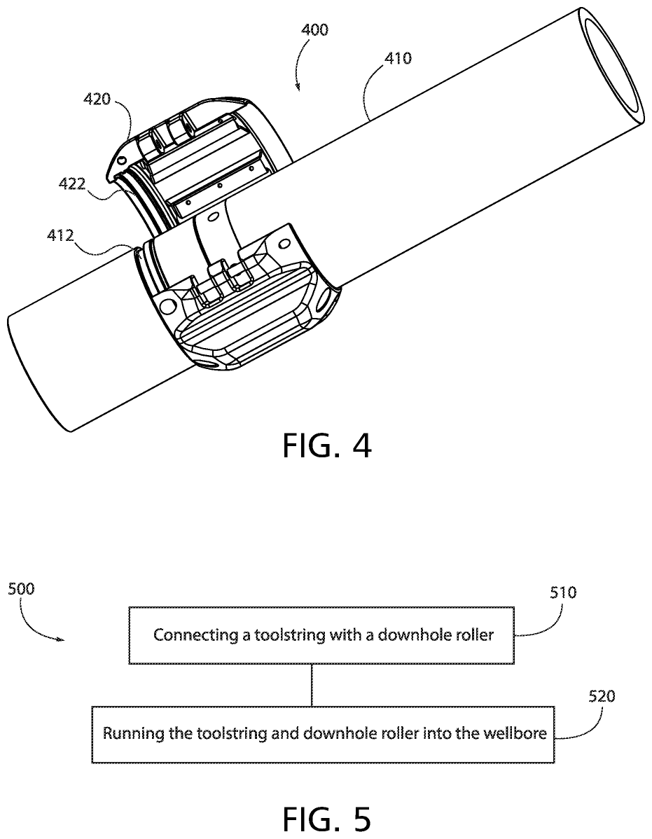

FIG. 4 depicts an example standoff having retaining lips formed on a surface thereof. The standoff 400 can include a standoff body 420. The standoff body 420 can have one or more retaining lips 422 formed on an interior thereof. The standoff 400 can be connected about a tubular 410. The tubular 410 can have one or more retaining groves 412 configured to operatively cooperate with the retaining lips 422 to prevent axial movement of the standoff on the tubular 410.

FIG. 5 depicts an example method of conveying a downhole tool. The method 500 includes connecting a toolstring with a downhole roller, Box 510. The downhole roller can be any roller described herein or substantially similar downhole rollers. The downhole roller can be connected with the toolstring using a hinge pin design. For example, the downhole roller can be hinged at one end and pinned at the other end; the pin can be removed allowing the pinned end to open allowing the downhole roller to be placed about the toolstring, and after being placed about the toolstring, the pinned end can be closed and the pin inserted therein preventing the pin end from opening. The method can also include running the toolstring and downhole roller into the wellbore, Box 520.

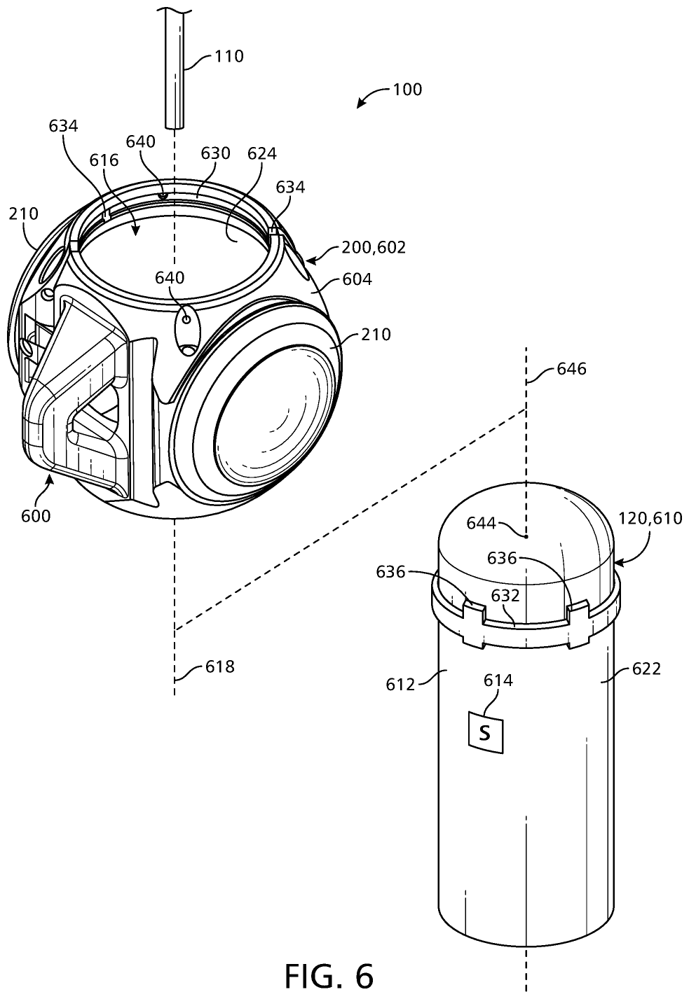

FIG. 6 is a perspective view of an embodiment of a portion of the system 100, in which the downhole roller 200 includes an orienting feature 600. Embodiments of the downhole roller 200 including the orienting feature 600 will be referred to hereinafter as a roller assembly 602. As such, it should be understood that the roller assembly 602 may include some or all the features and/or components of the downhole roller 200. For example, the roller assembly 602 may include the wheels 210, which may be coupled to a body 604 of the roller assembly 602 in accordance with the techniques discussed above. Moreover, it should be understood that the orienting feature 600 may be included on any of the aforementioned embodiments of the downhole roller 200. As discussed in detail herein, the orienting feature 600 may facilitate retaining the roller assembly 602, and a downhole tool 610 (e.g., the toolstring 120) that may be coupled thereto, in a particular orientation (e.g., with respect to a surrounding geological formation) while the downhole tool 610 is conveyed through a wellbore via the conveyance 110 (e.g., a cable), for example.

In the illustrated embodiment, the downhole tool 610 includes a housing 612 that may house various components of the downhole tool 610. For example, the downhole tool 610 may include one or more sensors 614 that are disposed within and/or coupled to the housing 612 and enable the downhole tool 610 to measure wellbore parameters (e.g., geophysical and/or petrophysical properties of a wellbore) and/or properties of a casing that may be disposed within the wellbore. The sensors 614 may include accelerometers, rate sensors, pressure transducers, electromagnetic sensors, acoustic sensors, and/or any additional suitable sensors. Additionally or alternatively, the downhole tool 610 may include any other suitable components, mechanisms, and/or devices that facilitate operation of the downhole tool 610 within a wellbore.

In the illustrated embodiment, the body 604 of the roller assembly 602 defines a receiving channel 616 therein. The receiving channel 616 may extend through the body 604 along a first axis 618 (e.g., a central axis of the receiving channel 616). As discussed below, the roller assembly 602 may couple to (e.g., clamp onto) the downhole tool 610 such that, in an installed configuration 620 (see, e.g., FIG. 10) of the downhole tool 610 with the roller assembly 602, the downhole tool 610 extends through the receiving channel 616 and along the first axis 618. As such, in the installed configuration 620, an exterior surface 622 of the housing 612 of the downhole tool 610 may engage (e.g., contact) an interior surface 624 of the receiving channel 616 of the roller assembly 602. The downhole tool 610 and the roller assembly 602, when coupled to one another in the installed configuration 620, may be referred to hereinafter as a downhole assembly 626 (see, e.g., FIG. 10).

In some embodiments, one or more first grooves 630 may be formed in the body 604 and one or more first protrusions 632 may be formed on the housing 612. In the installed configuration 620 of the roller assembly 602 with the downhole tool 610, the first grooves 630 may engage with corresponding first protrusions 632 of the housing 612. As such, while the roller assembly 602 is coupled to the downhole tool 610, engagement between the first grooves 630 and the first protrusions 632 may block axial movement of the roller assembly 602 along and relative to the downhole tool 610.

Additionally or alternatively, one or more second grooves 634 may be formed in the body 604 and one or more second protrusions 636 may be formed on the housing 612. In the installed configuration 620 of the roller assembly 602 with the downhole tool 610, the second grooves 634 may engage with corresponding second protrusions 636 of the housing 612. As such, while the roller assembly 602 is coupled to the downhole tool 610, engagement between the second grooves 634 and the second protrusions 636 may block rotational motion of the roller assembly 602 relative to the downhole tool 610. It should be appreciated that, in other embodiments, one or more of the first and/or second grooves 630, 634 may be replaced with protrusions that may engage with corresponding grooves formed in the housing 612.

In some embodiments, the roller assembly 602 includes one or more retention apertures 640 formed therein. In certain embodiments, the retention apertures 640 may be aligned with at least one of the first grooves 630. The retention apertures 640 may receive fasteners that may extend through the retention apertures 640 and, in the installed configuration 620 of the downhole tool 610 with the roller assembly 602, engage with the housing 612. To this end, fasteners extending through the retention apertures 640 may, in the installed configuration 620, further facilitate blocking translational movement and/or rotational motion between the downhole tool 610 and the roller assembly 602.

In some embodiments, the downhole tool 610 may couple to the conveyance 110 at a point 644 positioned along a second axis 646 (e.g., a central axis) of the downhole tool 610. The downhole tool 610 may be rotationally balanced about the second axis 646, such that a center of gravity of the downhole tool 610 and/or a center of mass of the downhole tool 610 is positioned along (e.g., co-linear to) the second axis 646.

As discussed in detail herein, the roller assembly 602 may be rotationally balanced about the first axis 618. That is, a center of gravity of the roller assembly 602 and/or a center of mass of the roller assembly 602 may be positioned along (e.g., co-linear to) the first axis 618. In the installed configuration 620 of the roller assembly 602 on the downhole tool 610, the first axis 618 of the roller assembly 602 may be aligned with and positioned substantially co-linear to the second axis 646 of the downhole tool 610. In this manner, the downhole assembly 626 (e.g., the roller assembly 602 and the downhole tool 610 in the installed configuration 620) may be substantially rotationally balanced about the first and second axes 618, 646. In other words, the downhole assembly 626 may be rotational balanced about the first axis 618 extending along the receiving channel 616 and the second axis 646 extending along the housing 612.

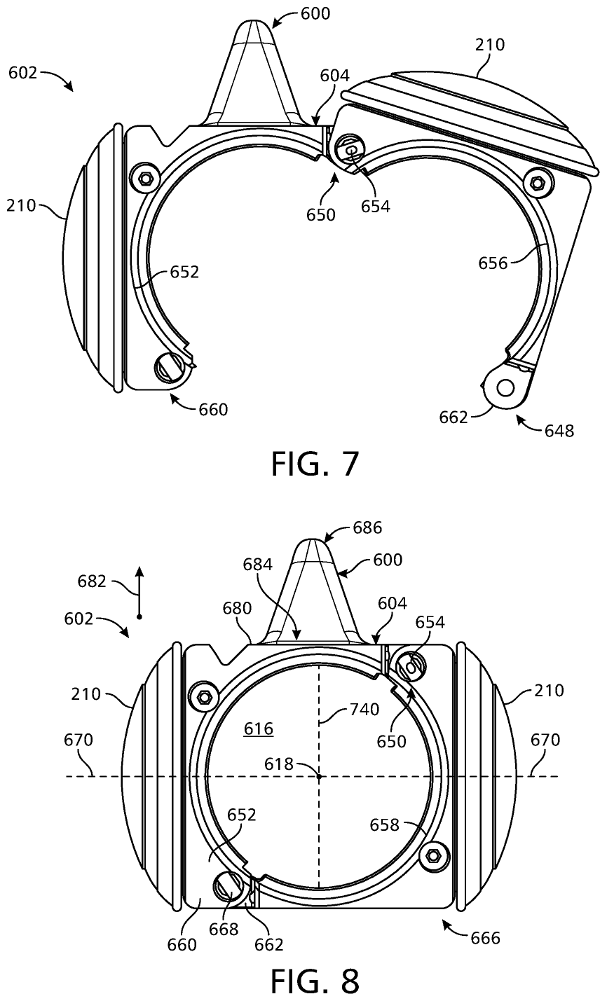

FIG. 7 is an elevation view of an embodiment of the roller assembly 602 in an open configuration 648. As shown in the illustrated embodiment, the roller assembly 602 includes a hinge 650 that enables a first portion 652 of the body 604 (e.g., a first portion of the roller assembly 602) to pivot about a third axis 654 of the hinge 650, relative to a second portion 656 of the body 604 (e.g., a second portion of the roller assembly 602). In accordance with the techniques discussed above, the hinge 650 may thereby enable an operator (e.g., an user of the system 100) to dispose the roller assembly 602 about the housing 612 of the downhole tool 610 (e.g., when the roller assembly 602 is in the open configuration 648) to engage the roller assembly 602 with the housing 612.

In the illustrated embodiment, the roller assembly 602 includes a receiver 660 that is coupled to or extends from the first portion 652 and one or more tabs 662 that are coupled to or extend from the second portion 656. The receiver 660 may receive the tabs 662 in a closed configuration 666 (see, e.g., FIG. 8) of the roller assembly 602 to retain the roller assembly 602 in the closed configuration 666. For example, to better illustrate, FIG. 8 is an elevation view of an embodiment of the roller assembly 602 in the closed configuration 666. In the closed configuration 666, a pin 668 or rod may extend through corresponding apertures formed in the receiver 660 and the tabs 662 to lock the receiver 660 to the tabs 662 and facilitate retaining the roller assembly 602 in the closed configuration 666. As such, in the closed configuration 666, the roller assembly 602 may wrap about an exterior of the downhole tool 610 to couple the roller assembly 602 to the downhole tool 610.

In some embodiments, each of the wheels 210 may rotate about a common axis 670 or a set of axes that are substantially parallel to one another. For example, in some embodiments, the common axis 670 may extend across diametrically opposite ends of the receiving channel 616. In other embodiments, the wheels 210 may rotate about respective axes that extend oblique to one another. In some embodiments, the common axis 670 may extend orthogonal or cross-wise to the first axis 618.

As shown in the illustrated embodiment of FIG. 8, the orienting feature 600 may include a portion of the body 604 that extends radially outward from the first axis 618. Particularly, in some embodiments, the orienting feature 600 may extend outwardly from a first surface 680 of the body 604 along a first direction 682 or axis that may extend orthogonal or cross-wise to the first axis 618 and the common axis 670. The orienting feature 600 may be formed integrally with the body 604 or may be a separate component that is coupled to the body 604 via fasteners, adhesives, and/or a metallurgical process, such as welding or brazing. In some embodiments, the orienting feature 600 may include a tapered cross-sectional profile, such that a base 684 of the orienting feature 600 (e.g., a portion of the orienting feature 600 at the first surface 680) includes a width dimension (e.g., a dimension extending along the common axis 670) that exceeds a width dimension (e.g., a dimension extending along the common axis 670) of a tip 686 or vertex of the orienting feature 600 (e.g., a distal end of the orienting feature 600; a radially outermost end of the orienting feature 600 with respect to the first axis 618). In other embodiments, the orienting feature 600 may include any other suitable cross-sectional profile or shape.

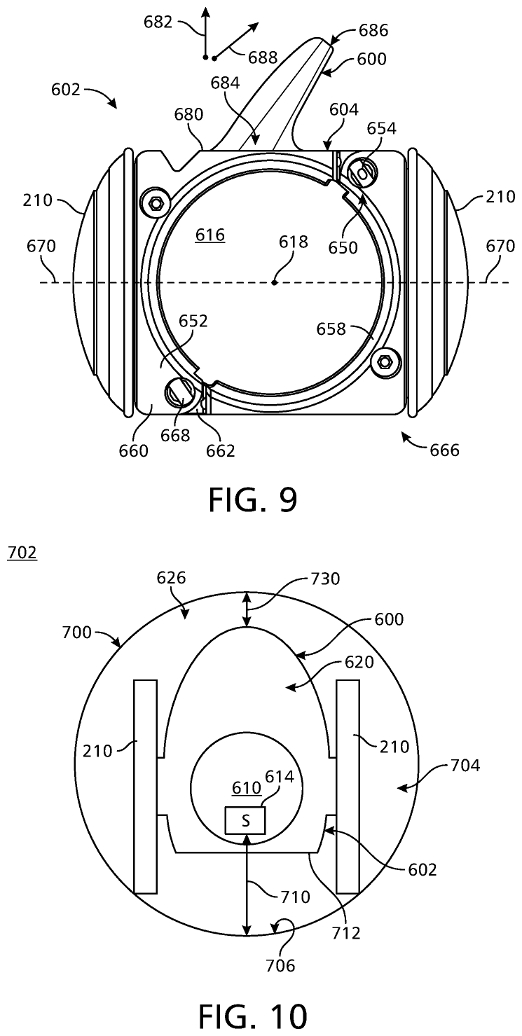

Although the orienting feature 600 has been described as extending along the first direction 682, which may extend generally orthogonal to the first surface 680, it should be appreciated that, in other embodiments, the orienting feature 600 may extend from the first surface 680 in any other suitable direction or along another suitable axis. For example, in some embodiments, the orienting feature 600 may extend from the first surface 680 in an oblique direction 688 (see e.g., FIG. 9) that extends oblique to the first surface 680.

As briefly discussed above, the orienting feature 600 enables the roller assembly 602 to facilitate retaining the downhole tool 610 in a particular orientational direction with respect to a wellbore during, for example, well-logging operations that may be performed using the system 100. For example, to better illustrate and to facilitate the following discussion, FIG. 10 is a schematic of an embodiment of the downhole assembly 626 disposed within a wellbore 700 of a geological formation 702. In the illustrated embodiment of FIG. 10, the downhole assembly 626 is in a stable configuration 704 or orientation, in which the wheels 210 of the roller assembly 602 are engaged with (e.g., in contact with) a surface 706 (e.g., inner surface) of the wellbore 700.

In some embodiments, it may be desirable to maintain certain of the sensors 614 at a target distance 710 from the surface 706 and/or to orient the sensors 614 at a particular angle with respect to the surface 706 during well-logging operations that may be performed using the system 100. For example, in some embodiments, the downhole tool 610 may be positioned within and coupled to the roller assembly 602 such that, in the installed configuration 620 of the downhole tool 610 within the roller assembly 602, the sensors 614 are located along a sensing side 712 of the roller assembly 602. The sensing side 712 may be generally opposite to the side of the roller assembly 602 having the orienting feature 600 extending therefrom.

While the wheels 210 are engaged with the surface 706, the roller assembly 602 may maintain the sensors 614 at the target distance 710 from the surface 706, or at a distance that is within a threshold range of the target distance 710. The wheels 210 may roll or otherwise travel along the surface 706 as the downhole assembly 626 is lowered into or drawn out of the wellbore 700 via the conveyance 110.

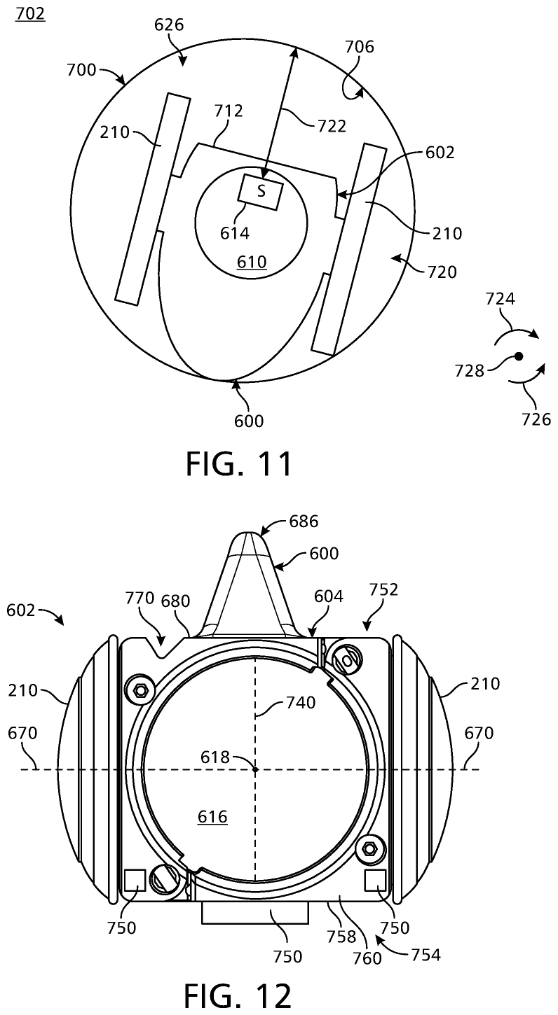

FIG. 11 is a schematic of an embodiment of the downhole assembly 626 in an unstable configuration 720 within the wellbore 700. In the unstable configuration 720, the orienting feature 600 may contact the surface 706, while one of or both of the wheels 210 do not contact (at least temporarily) the surface 706. In some cases, bends, curvatures, or other changes in direction (e.g., with respect to gravity) of a path of the wellbore 700 may occasionally cause the downhole assembly 626 to transition to the unstable configuration 720 while being conveyed along the wellbore 700 (e.g., via the conveyance 110). In the unstable configuration 720, a distance 722 between the sensors 614 and the surface 706 may exceed or otherwise deviate from the desired target distance 710.

Engagement between the orienting feature 600 and the surface 706, such as while the conveyance 110 conveys the downhole assembly 626 along the wellbore 700, may impart a force on the downhole assembly 626 (e.g., due to friction between the surface 706 and the orienting feature 600) that causes the downhole assembly 626 to jostle, vibrate, or otherwise move in a manner that persuades the downhole assembly 626 to return to the stable configuration 704. For example, while traveling along a portion of the wellbore 700 that extends along a generally horizontal direction (e.g., a direction offset or oblique to a direction of gravity) in the unstable configuration 720, engagement between the orienting feature 600 and a profile (e.g., an irregular profile) of the surface 706 may impart a force on the downhole assembly 626 that jostles, shakes, vibrates, or otherwise rotates the downhole assembly 626 in a clockwise direction 724 or a counter-clockwise direction 726 about a borehole axis 728 of the wellbore 700 (e.g., an axis extending along a length of the wellbore 700). In this manner, engagement between the orienting feature 600 and the surface 706 may persuade the downhole assembly 626 back toward and to the stable configuration 704, in which each of the wheels 210 may contact the surface 706, the orienting feature 600 may be spaced apart from the surface 706 (e.g., by a distance 730; see, e.g., FIG. 10), and the sensors 614 may be positioned at the target distance 710 from the surface 706.

The following discussion continues with reference to FIG. 8. As discussed above, the roller assembly 602 may be rotationally balanced (e.g., substantially rotationally balanced) about the first axis 618. As used herein, the terms “rotationally balanced” or “substantially rotationally balanced” may indicate that an effective axis about which the roller assembly 602 is rotationally balanced is within a threshold distance of and/or within a threshold orientational range of a reference axis (e.g., the first axis 618). For example, in some embodiments, the roller assembly 602 may be substantially rotationally balanced about the first axis 618. As such, the effective axis about which the roller assembly 602 is rotationally balanced may be radially offset less than 1 millimeter (mm), less than 0.5 mm, or less than 0.25 mm of the first axis 618 and/or may be orientationally offset less than 1 degree, less than 0.5 degrees, or less than 0.25 degrees of first axis 618, for example. That is, the roller assembly 602 may be substantially rotationally balanced about the first axis 618 when a center of mass of the roller assembly 602 is within a threshold distance (e.g., less than 1 mm) of the first axis 618.

It should be appreciated that, in some embodiments, the roller assembly 602 may be substantially rotationally balanced about the common axis 670. In certain embodiments, the roller assembly 602 may be substantially rotationally balanced about an axis 740 that extends orthogonal to the first axis 618 and the common axis 670 and extends along the first direction 682. As such, it should be appreciated that the roller assembly 602 may be rotationally balanced about the first axis 618, the common axis 670, the axis 740, or any combination thereof

FIG. 12 is an elevation view of an embodiment of the roller assembly 602 having one or more counter-weight features 750. In some embodiments, the roller assembly 602 may include the counter-weight features 750 to ensure that, even through the orienting feature 600 extends outward (e.g., radially outward) from the first surface 680, the roller assembly 602 remains rotationally balanced about the first axis 618.

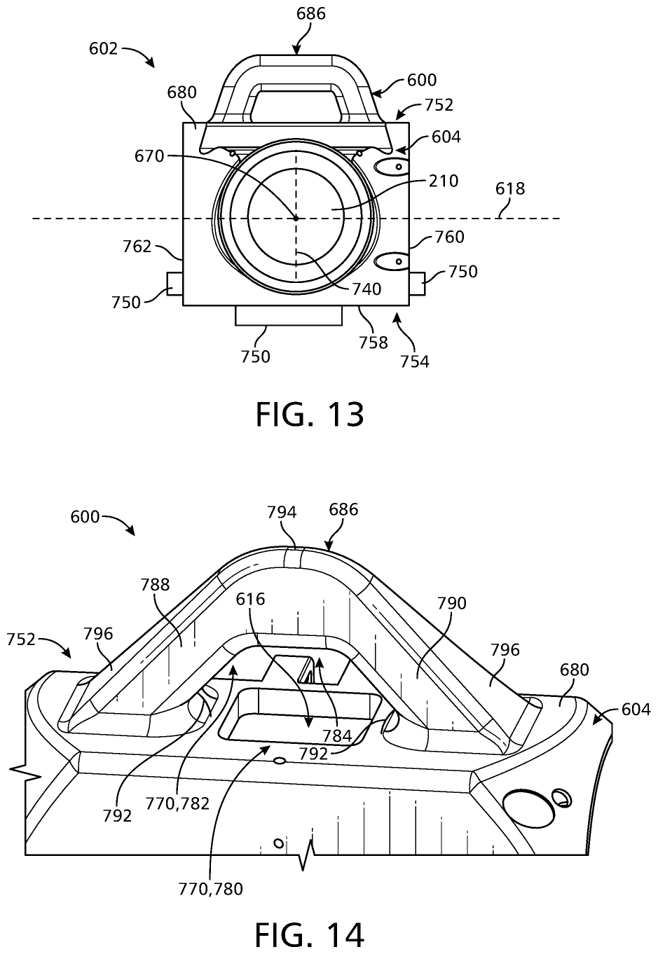

For example, in some embodiments, the counter-weight features 750 may be coupled to or formed integrally with a portion of the body 604 that is generally opposite to the portion of the body 604 having the orienting feature 600. Particularly, the orienting feature 600 may be located at a first end portion 752 of the body 604, while the counter-weight features 750 may be located at a second end portion 754 of the body 604 that is opposite to the first end portion 752. In some embodiments, the counter-weight features 750 may be coupled to or otherwise extend from a portion of a second surface 758 of the body 604 that is near the second end portion 754 and opposite to the first surface 680. Additionally or alternatively, the counter-weight features 750 may be coupled to or otherwise extend from a portion of a third surface 760 of the body 604 (e.g., a surface extending between the first surface 680 and the second surface 758) that is near the second end portion 754. Further, in certain embodiments, the counter-weight features 750 may be coupled to or otherwise extend from a portion of a fourth surface 762 (see, e.g., FIG. 13) of the body 604 (e.g., a surface extending between the first surface 680 and the second surface 758; a surface opposite the third surface 760) that is near the second end portion 754. Indeed, it should be appreciated that the counter-weight features 750 may be coupled to or otherwise extend from any suitable portion of the body 604 that enables the roller assembly 602 to be rotationally balanced about the first axis 618, for example. Moreover, in certain embodiments, the counter-weight features 750 may be coupled to or otherwise extend from the body 604 to facilitate rotationally balancing the roller assembly 602 about the common axis 670 and/or the axis 740 in addition to, or in lieu of, the first axis 618.

In some embodiments, the roller assembly 602 may include one or more weight-reducing features 770 in addition to, or in lieu of, the counter-weight features 750, which may facilitate rotationally balancing the roller assembly 602 about the first axis 618, the common axis 670, and/or the axis 740. As a non-limiting example, the weight-reducing features 770 may include slots, channels, grooves, cut-outs, or other features formed in the body 604 that enable weight removal from portions of the body 604, such as near the first end portion 752 of the body 604 (e.g., near a portion of the body 604 having the orienting feature 600). The weight-reducing features 770, alone or in combination with the counter-weight features 750, may ensure that a weight of the orienting feature 600 does not offset an axis of rotational balance of the roller assembly 602 with respect to, for example, the first axis 618.

FIG. 14 is a perspective view of an embodiment of the orienting feature 600 of the roller assembly 602. In some embodiments, the weight-reducing features 770 may include one or more cutouts 780 (e.g., channels, passages, openings, indentations) formed in the first end portion 752 of the body 604. In some embodiments, the cutouts 780 may include a passage that extends from the first surface 680 to the receiving channel 616, for example, and/or may be positioned between respective portions of the orienting feature 600.

Additionally or alternatively, the weight-reducing features 770 may include one or more cutouts 782 (e.g., channels, passages, openings, indentations) formed in the orienting feature 600. For example, in the illustrated embodiment, a cutout 782 extends through a width dimension of the orienting feature 600 to form a channel 784 or passage through the orienting feature 600. The channel 784 may be bound by a first portion 788 of the orienting feature 600, a second portion 790 of the orienting feature 600, and a least a portion of the first surface 680. As such, the channel 784 may shape the orienting feature 600 into a handle-shaped form, which may enable an operator to utilize the orienting feature 600 as a handle by which to grasp the roller assembly 602. To this end, the orienting feature may be gasped by the operator to facilitate transportation of the roller assembly 602, installation of the roller assembly 602 (e.g., on the downhole tool 610), or other operations of the roller assembly 602.

In the illustrated embodiment of FIG. 14, the orienting feature 600 includes a generally triangular shape. Specifically, the orienting feature 600 includes the first portion 788 and the second portion 790 that extend from the first surface 680 at angles 792 relative to the first surface 680 and converge or abut at a vertex 794 (e.g., the tip 686). Accordingly, respective angled surfaces 796 of the first and second portions 788, 790 and/or the vertex 794 may engage with the surface 706 (see, e.g., FIG. 11) of the wellbore 700 while the downhole assembly 626 (see, e.g., FIG. 11) is conveyed along the wellbore 700. It should be appreciated that, in other embodiments, the orienting feature 600 may include any other suitable shape or profile, as various shapes, profiles, and/or geometries of the orienting feature 600 are envisioned.

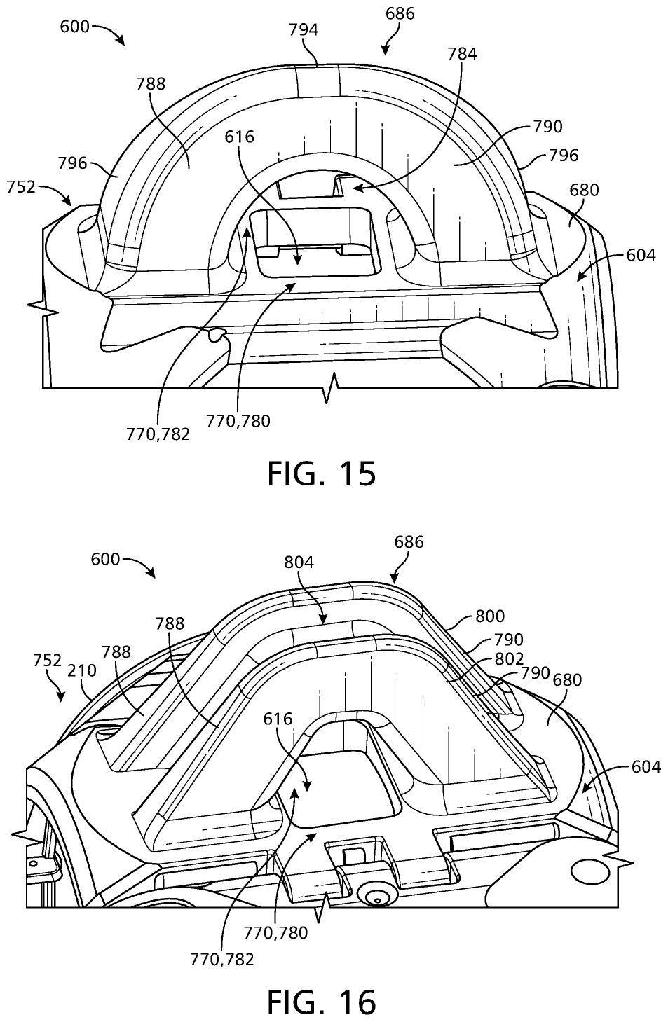

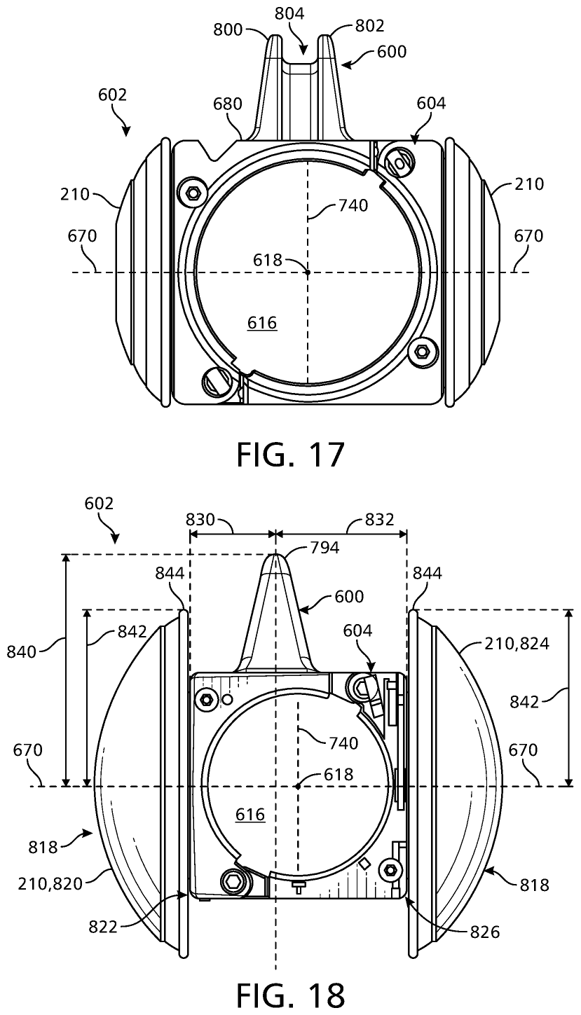

For example, FIG. 15 is a perspective view of an embodiment of the orienting feature 600 that has a generally oval (e.g., oblong) or semi-circular shape. As another example, FIG. 16 is a perspective view of an embodiment of the orienting feature 600 that includes a ribbed profile or shape. FIG. 17 is an elevation view of an embodiment of the roller assembly 602 having the ribbed orienting feature 600. As shown in the illustrated embodiments of FIGS. 16 and 17, the orienting feature 600 may include a first rib 800 and a second rib 802 that are separated via a channel 804 extending along a profile or length of the orienting feature 600. That is, the channel 804 may extend along a length of the orienting feature 600 to form the first rib 800 and the second rib 802 of the orienting feature 600, which may be spaced apart via the channel 804.

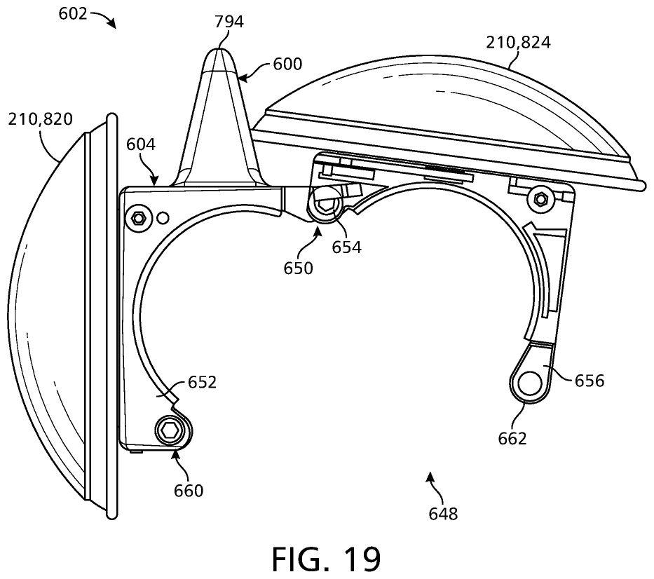

FIG. 18 is an elevation view of an embodiment of the roller assembly 602 having augmented wheels 818 (e.g., over-sized wheels) that may include diametric dimensions that exceed diametric dimensions of the wheels 210. In the illustrated embodiment, a first wheel 820 of the augmented wheels 818 is coupled to a first side portion 822 of the body 604 and a second wheel 824 of the augmented wheels 818 is coupled to a second side portion 826 of the body 604. A first dimension 830 (e.g., a dimension along the common axis 670) between the first side portion 822 and the vertex 794 of the orienting feature 600 may be less that a second dimension 832 (e.g., a dimension along the common axis 670) between the second side portion 826 and the vertex 794. As such, the orienting feature 600 may be offset from a center of the body 604 (e.g., with respect to a width dimension along the common axis 670) and biased near the first side portion 822 of the body 604. Biasing the orienting feature 600 near the first side portion 822 may enable the roller assembly 602 (having the augmented wheels 818) to transition to the open configuration 648 (see, e.g., FIG. 19) without interference between the orienting feature 600 and the second wheel 824. It should be understood that the orienting feature 600 may be biased near the first side portion 822 (or near the second side portion 826) in any of the embodiments of the roller assembly 602 discussed herein. The roller assembly 602 with a biased orienting feature 600 may be rotationally balanced about the first axis 618, the common axis 670, and/or the axis 740. As previously described, in some embodiments, the roller assembly 602 may include one or more weight-reducing features in addition to, or in lieu of, the counter-weight features to facilitate rotationally balancing the roller assembly 602 about the first axis 618, the common axis 670, and/or the axis 740.

In some embodiments, a portion of the second wheel 824 may extend into the channel 784 (see, e.g., FIG. 14) of the orienting feature 600 to enable further clearance between the second wheel 824 and the orienting feature 600 when the roller assembly 602 is in the open configuration 648. As shown in the illustrated embodiment of FIG. 18, a first radial dimension 840 from the common axis 670 to the vertex 794 may exceed respective radial dimensions 842 from the common axis 670 to diametric end portions 844 of the first and second wheels 820, 824.

The preceding description has been presented with reference to certain embodiments. Persons skilled in the art and technology to which these embodiments pertain will appreciate that alterations and changes in the described structures and methods of operation may be practiced without meaningfully departing from the principle, and scope of these embodiments. Regardless, the foregoing description should not be read as pertaining only to the precise structures described and shown in the accompanying drawings, but rather should be read as consistent with and as support for the following claims, which are to have their fullest and fairest scope.

1. A roller assembly, comprising:
a body having a receiving channel extending along an axis, wherein the receiving channel is configured to receive a downhole tool;
a wheel coupled to the body and configured to rotate relative to the body; and
an orienting feature of the body, wherein the orienting feature extends from a surface of the body and outwardly from the axis, and wherein the roller assembly is rotationally balanced about the axis.

2. The roller assembly of claim 1, wherein the orienting feature comprises a first portion extending from the surface and a second portion extending from the surface, wherein the first portion and the second portion converge at a vertex of the orienting feature.

3. The roller assembly of claim 2, comprising a cutout extending through the orienting feature and forming a passage between the surface, the first portion, and the second portion.

4. The roller assembly of claim 1, wherein the wheel is a first wheel coupled to a first side portion of the body, the roller assembly comprises a second wheel coupled to a second side portion of the body, and the first wheel and the second wheel are configured to rotate about an additional axis.

5. The roller assembly of claim 4, wherein a first radial dimension from the additional axis to a vertex of the orienting feature exceeds respective second radial dimensions from the additional axis to corresponding diametric ends of the first and second wheels.

6. The roller assembly of claim 4, wherein a first dimension along the additional axis between the first side portion of the body and the orienting feature is less than a second dimension along the additional axis between the second side portion of the body and the orienting feature.

7. The roller assembly of claim 1, wherein the orienting feature comprises a triangular shape or an oblong shape.

8. The roller assembly of claim 1, wherein the orienting feature includes a channel formed therein and extending along a profile of the orienting feature to define a first rib and a second rib of the orienting feature.

9. The roller assembly of claim 1, wherein the orienting feature comprises a first portion and a second portion extending from the surface, wherein the body comprises a cutout positioned between the first portion and the second portion and extending from the surface to the receiving channel.

10. The roller assembly of claim 1, wherein the orienting feature extends outwardly from the axis from a first end portion of the body, wherein the body comprises a second end portion, opposite to the first end portion, and wherein the roller assembly comprises one or more counter-weight features coupled to or formed in the second end portion of the body.

11. A system, comprising:
a downhole tool; and
a roller assembly, comprising:
a body having a receiving channel formed therein and configured to receive the downhole tool;
a wheel coupled to the body and configured to rotate relative to the body; and
an orienting feature protruding from a surface of the body and extending outwardly from a central axis of the receiving channel, wherein the roller assembly is rotationally balanced about the central axis.

12. The system of claim 11, wherein the downhole tool is rotationally balanced about an additional axis of the downhole tool, and wherein, in an installed configuration of the downhole tool with the roller assembly, the additional axis is co-linear to the central axis.

13. The system of claim 11, wherein the central axis is a first axis, the wheel is configured to rotate about a second axis extending orthogonal to the first axis, and the orienting feature extends from the surface along a third axis orthogonal to the first axis and the second axis.

14. The system of claim 11, wherein the body comprises:
a first portion having the wheel coupled thereto;
a second portion having an additional wheel coupled thereto; and
a hinge pivotably coupling the first portion to the second portion to enable the roller assembly to transition between an open configuration to receive the downhole tool and a closed configuration to wrap about an exterior of the downhole tool.

15. The system of claim 14, wherein the first portion comprises a receiver and the second portion comprises one or more tabs, wherein the one or more tabs are configured to engage with the receiver in the closed configuration of the roller assembly.

16. The system of claim 11, wherein the orienting feature comprises a triangular profile, an oblong profile, a semi-circular profile, or a ribbed profile.

17. The system of claim 11, wherein the orienting feature comprises a first portion extending from the surface and a second portion extending from the surface, wherein the first and second portions abut one another and define a channel between the first portion, the second portion, and the surface.

18. A system, comprising:
a downhole tool configured to be conveyed through a wellbore; and
a roller assembly configured to couple to the downhole tool, the roller assembly comprising:
a receiving channel extending through a body of the roller assembly and along a first axis, wherein the receiving channel is configured to receive the downhole tool;
a plurality of wheels configured to engage with a surface of the wellbore and rotate about a second axis; and
an orienting feature extending orthogonal to the first axis and the second axis and configured to engage with the surface of the wellbore, wherein a center of mass of the roller assembly is along the first axis.

19. The system of claim 18, comprising the body of the roller assembly, wherein the orienting feature is formed integrally with the body.

20. The system of claim 18, comprising a cable coupled to the downhole tool and configured to convey the downhole tool and the roller assembly through the wellbore.
